(19) United States
(12) Patent Application Publication
(10) Pub. No.: US 2010/0070081 A1
(43) Pub. Date: Mar. 18, 2010

(54) REFRIGERATING APPARATUS CONTROL CIRCUIT, REFRIGERATING SYSTEM, AND REFRIGERATING APPARATUS CONTROL METHOD

(76) Inventors: Hisaaki Takaoka, Osaka (JP); Susumu Matsui, Osaka (JP); Kiichirou Satou, Osaka (JP); Shuuhei Yamaguchi, Osaka (JP)

Correspondence Address: BIRCH STEWART KOLASCH & BIRCH, PO BOX 747, FALLS CHURCH, VA, 22040-0747, US

(21) Appl. No.: 12/517,340

(22) PCT Filed: Dec. 18, 2007
(86) PCT No.: PCT/JP2007/074327

§ 371 Date: Jun. 2, 2009

(30) Foreign Application Priority Data
Dec. 19, 2006 (JP) 2006-340757
Dec. 7, 2007 (JP) 2007-317163

(51) Int. Cl. G05B 15/00

(52) U.S. Cl. 700/275

(57) ABSTRACT

A refrigerating driving control section controls the driving of the refrigerating apparatus. A control constant storage section stores data in which information indicating the object to be refrigerated by the refrigerating apparatus and control constants that the refrigerating driving control section adopts for the object are associated together. An operation of operation section specifies the object. From the control constant storage section, the refrigerating driving control section reads the control constants corresponding to the object specified by the operation section, and the driving of the refrigerating apparatus is controlled on the basis of the read control constants.

### TECHNICAL FIELD

The present invention relates to refrigerating apparatuses, and particularly to a technique for making temperature settings suitable for the object to be refrigerated.

### BACKGROUND ART

A refrigerating apparatus, e.g. a refrigerated container, stores objects to be refrigerated. The temperature is then set suitably for the objects to be refrigerated. For such temperature settings, Patent Document 1, for example, proposes a technique for inputting data from outside into a control unit that controls a refrigerated container.

Patent Document 1: Japanese Patent Application Laid-Open No. 2001-325205

### DISCLOSURE OF THE INVENTION

### Problems to be Solved by the Invention

However, even when data is properly inputted, the refrigerating conditions in the refrigerating apparatus cannot be suitably set without technical knowledge sufficient to properly handle the data. For example, simply inputting temperature settings into a panel can be made without technical knowledge, but determining to what temperatures the settings should be made requires knowledge about the object to be refrigerated and about the control of the refrigerated container.

When various refrigerating conditions, including temperature settings, are wrong, the object to be refrigerated cannot be suitably refrigerated and its quality will deteriorate.

Considering such situations, an object of the present invention is to provide a technique for suitably refrigerating an object to be refrigerated by driving a refrigerating apparatus under suitable refrigerating conditions just by specifying the object to be refrigerated even when the user does not know detailed refrigerating conditions.

### Means for Solving the Problems

A refrigerating apparatus control circuit according to the present invention comprises: a refrigerating driving control section (11) that controls driving of the refrigerating apparatus (3); a control constant storage section (12) that stores, for a plurality of objects, data (120) in which information (Li) indicating an object (4) to be refrigerated by said refrigerating apparatus (3) and a control constant (Ci, Di, Ei, . . . ) that said refrigerating driving control section adopts for that object are associated together; and an operation section (14) that operates to specify said object. Said refrigerating driving control section (11) reads from said control constant storage section said control constant corresponding to said object specified by said operation section, and controls the driving of said refrigerating apparatus on the basis of read said control constant.

Desirably, in each said data, said control constant has first control constants (Ci1, Ci2, Ci3) determining a plurality of setting temperatures (F1, F2, F3), and second control constants (Ti1, Ti2, Ti3) determining a plurality of setting times (τ1, τ2, τ3) that said setting temperatures should respectively take, and the driving of said refrigerating apparatus is controlled in correspondence with said object on the basis of said setting temperatures and said setting times.

Desirably, in each said data, a first (F1) of said plurality of setting temperatures is set in a chilled temperature zone, a second (F2) of said plurality of setting temperatures is set in a frozen temperature zone, and a third (F3) of said plurality of setting temperatures is set in a temperature zone that is suitable for transportation of said object to which that data corresponds.

Desirably, in each said data, said plurality of setting times are set corresponding to transportation of said object to which said data corresponds.

A refrigerating system according to the present invention comprises: the refrigerating apparatus control circuit (1) according to the present invention; and said refrigerating apparatus (3). Desirably, it further comprises a refrigerated container (2) containing said refrigerating apparatus (3).

A refrigerating apparatus control method according to the present invention comprises steps of: (a) displaying (S2) a plurality of objects (4) to be refrigerated by a refrigerating apparatus (3); (b) inputting (S3) to specify one of said objects; (c) reading (S4), from a control constant storage section (12), a control constant (Ci, Di, Ei, . . . ) that corresponds to said one of said objects specified in said step (b) and that is adopted to control driving of said refrigerating apparatus; and (d) controlling (S5) the driving of said refrigerating apparatus on the basis of said control constant read in said step (c).

Desirably, said control constant has first control constants (Ci1, Ci2, Ci3) determining a plurality of setting temperatures (F1, F2, F3), and second control constants (Ti1, Ti2, Ti3) determining a plurality of setting times (τ1, τ2, τ3) that said setting temperatures should respectively take, and in said step (d), the driving of said refrigerating apparatus is controlled in correspondence with said object on the basis of said setting temperatures and said setting times.

Desirably, in each said data, a first (F1) of said plurality of setting temperatures is set in a chilled temperature zone, a second (F2) of said plurality of setting temperatures is set in a frozen temperature zone, and a third (F3) of said plurality of setting temperatures is set in a temperature zone that is suitable for transportation of said object to which that data corresponds.

Desirably, in each said data, said plurality of setting times are set corresponding to transportation of said object to which said data corresponds.

Desirably, the method further comprises a step of: (e) performed prior to said steps (a) to (d), storing in said control constant storage section (12), and for each said object (4), data (120) in which information (Li) indicating an object and a control constant (Ci, Di, Ei, . . . ) that said refrigerating driving control section adopts for that object are associated together.

### EFFECTS OF THE INVENTION

According to the refrigerating apparatus control circuit of the present invention, the refrigerating system using the same, and the refrigerating apparatus control method of the present invention, it is possible to suitably refrigerate an object to be refrigerated by driving a refrigerating apparatus under suitable refrigerating conditions just by specifying the object to be refrigerated even when the user does not know detailed refrigerating conditions.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 A block diagram illustrating the configuration of a refrigerating system according to one preferred embodiment of the present invention.

FIG. 2 A flowchart illustrating the operation of the refrigerating system of this preferred embodiment.

FIG. 3 A conceptual diagram illustrating a display section displaying a screen for selecting an object to be transported.

FIG. 4 A conceptual diagram illustrating a display for container temperature.

FIG. 5 A diagram illustrating the structure of data stored in a control constant storage section.

FIG. 6 A diagram illustrating the structure of data stored in the control constant storage section.

FIG. 7 A graph illustrating a temperature variation in the refrigerated container.

### BEST MODE FOR CARRYING OUT THE INVENTION

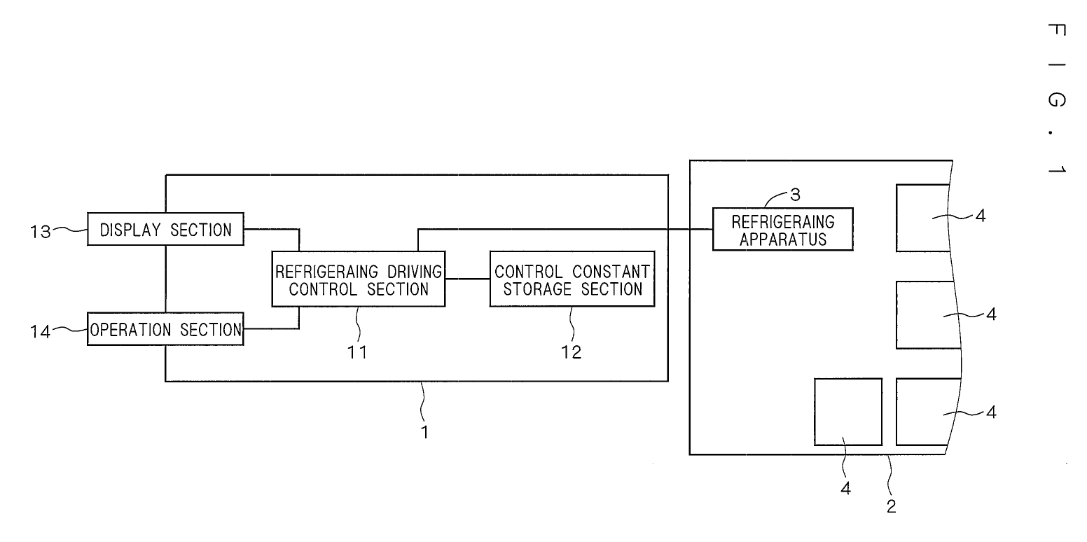

FIG. 1 is a block diagram illustrating the configuration of a refrigerating system according to one preferred embodiment of the present invention. This refrigerating system includes a refrigerating apparatus 3, a refrigerated container 2 that contains the refrigerating apparatus 3, and a control circuit 1 for controlling the refrigerating apparatus 3. The refrigerated container 2 stores objects 4 to be refrigerated by the refrigerating apparatus 3.

The control circuit 1 includes a refrigerating driving control section 11, a control constant storage section 12, a display section 13, and an operation section 14.

The control constant storage section 12 stores data 120 having a structure as illustrated in FIG. 5. The data 120 contains information Li indicating an object 4 and control constants Ci, Di, Ei, . . . in association. The subscripts i represent a plurality of numerical values, which are positive integers, for example. That is, a plurality of multiple data 120 structured as illustrated in FIG. 5 are provided in correspondence with the kinds of the objects 4.

The refrigerating driving control section 11 reads control constants from data 120 from the control constant storage section 12, and controls the driving of the refrigerating apparatus 3 on the basis of the control constants. The control constants Ci, Di, Ei, . . . are values that are adopted by the refrigerating driving control section 11 for the object 4 indicated by the information Li, which determine the settings of temperature, the settings of humidity, the intervals of dehumidification, and the amount of ventilation, for example. These control constants are chosen depending on the performance of the entire refrigerating system, such as the ability of the refrigerating apparatus 3 and the size of the refrigerated container 2, and the kind of the object 4, e.g. whether the object 4 is apples, pineapples, or tuna. The control constants are stored in the control constant storage section 12 before the refrigerating process is conducted.

The display section 13 and the operation section 14 are provided such that they can be easily checked and operated from outside of the control circuit 1, and FIG. 1 shows such a condition by depicting the display section 13 and the operation section 14 sticking out of the control circuit 1. It is not always necessary to separately provide the display section 13 and the operation section 14 as shown in FIG. 1, but they may be located closely, or may be provided as a unit by adopting a touch panel.

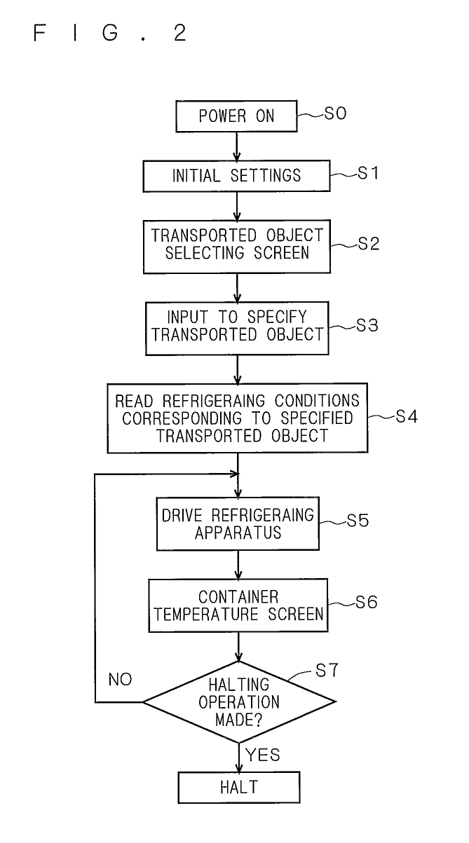

FIG. 2 is a flowchart illustrating the operation of the refrigerating system of this preferred embodiment. First, when the power is turned on in Step S0, the refrigerating driving control section 11 makes initial settings of the refrigerating apparatus 3. The initial settings are known operations usually made, like checking the refrigerating apparatus 3 for abnormalities, and performing preparatory operation of the refrigerating apparatus 3 (e.g. preheating of the motor for driving the compressor). The initial settings are not described in detail herein because they are not directly related to the present invention.

Next, in Step S2, the display section 13 displays a transported object selecting screen for selecting the object to the transported. FIG. 3 is a conceptual diagram illustrating the display section 13 displaying a transported object selecting screen. This shows an example in which the operation section 14 is provided close to the display section 13 in a panel 10.

The transported object selecting screen displays a title “Select Transported Object”, together with “1: Apples”, “2: Pineapples”, “3: Tuna”, etc. The user operates the operation section 14 to select the kind of the object 4 stored in the refrigerated container 2.

For example, the operation section 14 has operating buttons 141, 142, 143 and 144. The operating button 141 (the button indicated as “S”) is operated to offer a function of switching the transported object selecting screen and a container temperature screen display that displays container temperature (which will be described later). The operating buttons 142 and 143 (the buttons respectively indicated as “Δ” and “∇”) have functions of respectively increasing and decreasing to specify items and numerical values displayed in the display section 13. The button 144 (the button indicated as “° C./° F.”) is operated to offer a function of, when the transported object selecting screen is displayed, specifying the selected object 4 to cause the control circuit 11 to recognize it. When a container temperature screen is displayed, it serves to switch the display of container temperature between Fahrenheit/Celsius.

In the transported object selecting screen, the operating buttons 142 and 143 are operated to select the object to be transported. The operating button 144 is then operated to specify the selected transported object (Step S3).

Then, in Step S4, the refrigerating driving section 11 reads the refrigerating conditions corresponding to the specified transported object from the control constant storage section 12. Specifically, when the specified object 4 is tuna, the corresponding information L3 serves as a search key to search the data 120, and the control constants C3, D3, E3, . . . corresponding to the information L3 are read out.

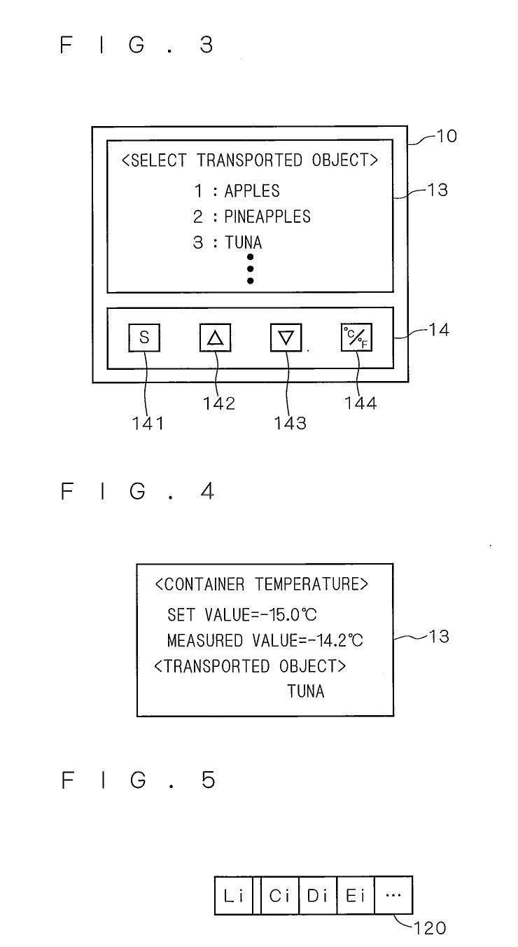

Then, in Step S5, the refrigerating driving control section 11 controls the driving of the refrigerating apparatus 3 on the basis of the control constants C3, D3, E3 thus read out. Then, in Step S6, the display section 13 displays a container temperature display. FIG. 4 is a conceptual diagram illustrating the container temperature display, where a set value and a measured value are displayed. Displaying the specified object 4 (transported object) together as shown in the diagram is advantageous because the user can easily notice a misoperation. If the user notices a misoperation, the user can make halting operation to the control circuit 1. When such halting operation is not made in Step S7, Steps S5 and S6 are continuously carried out, and the operation halts when halting operation is made. This enables prompt measures to be taken when the user notices wrong specification in Step S3.

By adopting such a configuration and operating method, it is possible to suitably refrigerate the object 4 to be refrigerated by driving the refrigerating apparatus 3 under suitable refrigerating conditions just by specifying the refrigerated object 4 even when the user does not know detailed refrigerating conditions.

Needless to say, it is desired to store, in the control constant storage section 12 prior to Step S2, and for each object 4, data 120 where the information Li indicating an object 4 and the control constants Ci, Di, Ei, . . . adopted by the refrigerating driving control section 11 for the object 4 are associated together.

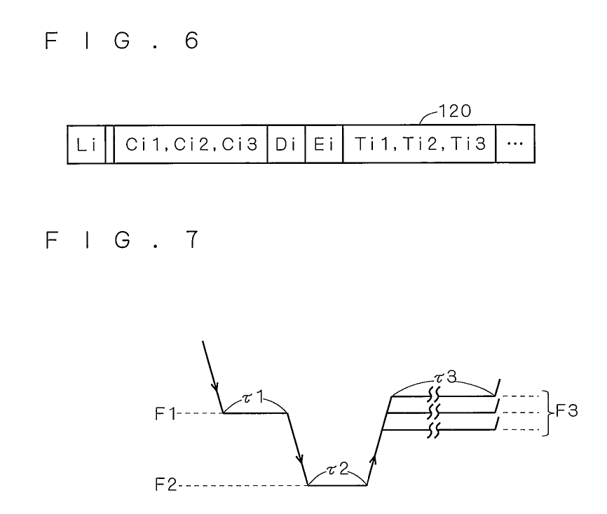

For example, the control constant Ci adopted for the object 4 indicated by the information Li may take a plurality of temperature setting values. FIG. 6 is a diagram illustrating the structure of data 120 in such a case. The data 120 stores control constants Ci1, Ci2 and Ci3 and further stores control constants Ti1, Ti2 and Ti3.

The control constants Ci1, Ci2 and Ci3 determine a plurality of setting temperatures, and the control constants Ti1, Ti2 and Ti3 respectively determine the setting times that the setting temperatures determined by the control constants Ci1, Ci2 and Ci3 should take. For example, a setting temperature F1 determined by the control constant Ci1 is maintained for a setting time it determined by the control constant Ti1, and then a setting temperature F2 determined by the control constant Ci2 is maintained for a setting time τ2 determined by the control constant Ti2, and then a setting temperature F3 determined by the control constant Ci3 is maintained for a setting time τ3 determined by the control constant Ti3.

FIG. 7 is a graph illustrating a temperature variation in the refrigerated container 2, where the setting temperatures F1 and F2 are set respectively in a chilled temperature zone (e.g. 2° C. below zero) and a frozen temperature zone (e.g. 18° C. below zero). The setting temperatures F1 and F2 are set to the temperatures shown above in order to confirm that the refrigerating apparatus 3 can make the refrigerated container 2 reach chilled temperature and frozen temperature.

The setting temperature F3 is set in a temperature zone that is suitable for the transportation of the object 4. FIG. 7 shows multiple kinds of objects 4 whose temperature zones suitable for transportation differ, and therefore a plurality of setting temperatures F3 are shown and the graph branches off.

Though it depends on the temperature suitable for the transportation of the object 4, when the quality of the object 4 does not deteriorate even when it is once refrigerated to the frozen temperature zone, the object 4 may be stored in the refrigerated container 2 before the setting temperature F2 is reached. Or, depending on the kind of the object 4, it may be stored in the refrigerated container 2 after the setting temperature F3 has been reached, or may be stored in the refrigerated container 2 before the setting temperature F1 is reached.

For example, when the temperature suitable for the transportation of the object 4 is in the frozen temperature zone, it is substantially unnecessary that the refrigerating apparatus 3 keep the refrigerated container 2 at chilled temperature. Accordingly, the setting time it corresponding to the kind of the object 4 can be set very short.

On the other hand, when the temperature suitable for the transportation of the object 4 is in the chilled temperature zone, it is substantially unnecessary that the refrigerating apparatus 3 keep the refrigerated container 2 at frozen temperature. Accordingly, the setting time τ2 corresponding to the kind of the object 4 can be set very short. Alternatively, when the object 4 is of a kind that should not be brought to frozen temperature, the setting temperature τ2 can be set at substantially zero, and the setting temperature F1 can be maintained for the setting time τ1 and then the temperature can be immediately shifted to the setting temperature F3.

In the above-described example, the setting temperatures F1 and F2 are set respectively in a chilled temperature zone and a frozen temperature zone in order to confirm that the refrigerating apparatus 3 can make the refrigerated container 2 reach chilled temperature and frozen temperature. However, the setting temperatures F1 and F2 may be set respectively in a frozen temperature zone and a chilled temperature zone. Alternatively, not only the setting temperature F3 but also the setting temperatures F1 and F2 may be temperatures suitable for the transportation of the object 4, and the setting times τ1 and τ2 may be set corresponding to the transportation.

Also, the control constant Di adopted for the object 4 indicated by the information Li may take a plurality of humidity setting values Di1, Di2 and Di3. Also in this case, as in the case where the control constant Ci takes a plurality of temperature setting values, it is desired that the data 120 contain control constants Ti1, Ti2 and Ti3 that respectively determine the setting times that the setting humidity values determined by the control constants Di1, Di2 and Di3 should take.

However, it is not always necessary to store control constants Ti1, Ti2 and Ti3 for determining the setting times described above. This is because they can be controlled as default values when they are at fixed values.

While the invention has been described in detail, the foregoing description is in all aspects illustrative and not restrictive. It is understood that numerous other modifications and variations can be devised without departing from the scope of the invention.

1-11. (canceled)

12. A refrigerating apparatus control circuit comprising:
a refrigerating driving control section that controls driving of a refrigerating apparatus;
a control constant storage section that stores, for a plurality of objects, data in which information indicating an object to be refrigerated by said refrigerating apparatus and a control constant that said refrigerating driving control section adopts for that object are associated together; and
an operation section that is operated to specify said object,
said refrigerating driving control section reading from said control constant storage section said control constant corresponding to said object specified by said operation section, and controlling driving of said refrigerating apparatus on the basis of read said control constant.

13. The refrigerating apparatus control circuit according to claim 12,
wherein, in each said data, said control constant has first control constants determining a plurality of setting temperatures, and second control constants determining a plurality of setting times that said setting temperatures should respectively last, and
the driving of said refrigerating apparatus is controlled in correspondence with said object on the basis of said setting temperatures and said setting times.

14. The refrigerating apparatus control circuit according to claim 13,
wherein, in each said data,
a first of said plurality of setting temperatures is set in a chilled temperature zone,
a second of said plurality of setting temperatures is set in a frozen temperature zone, and
a third of said plurality of setting temperatures is set in a temperature zone that is suitable for transportation of said object to which that data corresponds.

15. The refrigerating apparatus control circuit according to claim 13,
wherein, in each said data,
said plurality of setting times are set corresponding to transportation of said object to which said data corresponds.

16. A refrigerating system comprising:
a refrigerating apparatus control circuit according to claim 12; and
said refrigerating apparatus.

17. A refrigerating system comprising:
a refrigerating apparatus control circuit according to claim 13; and
said refrigerating apparatus.

18. A refrigerating system comprising:
a refrigerating apparatus control circuit according to claim 14; and
said refrigerating apparatus.

19. A refrigerating system comprising:
a refrigerating apparatus control circuit according to claim 15; and
said refrigerating apparatus.

20. The refrigerating system according to claim 16, further comprising a refrigerated container accommodating said refrigerating apparatus.

21. A refrigerating apparatus control method comprising steps of:
(a) displaying a plurality of objects to be refrigerated by a refrigerating apparatus;
(b) inputting to specify one of said objects;
(c) reading, from a control constant storage section, a control constant that corresponds to said one of said objects specified in said step (b) and that is adopted to control driving of said refrigerating apparatus; and
(d) controlling the driving of said refrigerating apparatus on the basis of said control constant read in said step (c).

22. The refrigerating apparatus control method according to claim 18,
wherein said control constant has first control constants determining a plurality of setting temperatures, and second control constants determining a plurality of setting times that said setting temperatures should respectively last, and
in said step (d), the driving of said refrigerating apparatus is controlled in correspondence with said object on the basis of said setting temperatures and said setting times.

23. The refrigerating apparatus control method according to claim 19,
wherein, in each said data,
a first of said plurality of setting temperatures is set in a chilled temperature zone,
a second of said plurality of setting temperatures is set in a frozen temperature zone, and
a third of said plurality of setting temperatures is set in a temperature zone that is suitable for transportation of said object to which that data corresponds.

24. The refrigerating apparatus control method according to claim 19,
wherein, in each said data,
said plurality of setting times are set corresponding to transportation of said object to which said data corresponds.

25. The refrigerating apparatus control method according to claim 18, further comprising a step of:
(e) performed prior to said steps (a) to (d), storing in said control constant storage section, and for each said object, data in which information indicating an object and a control constant that said refrigerating driving control section adopts for that object are associated together.

26. The refrigerating apparatus control method according to claim 19, further comprising a step of:
(e) performed prior to said steps (a) to (d), storing in said control constant storage section, and for each said object, data in which information indicating an object and a control constant that said refrigerating driving control section adopts for that object are associated together.

27. The refrigerating apparatus control method according to claim 20, further comprising a step of:
(e) performed prior to said steps (a) to (d), storing in said control constant storage section, and for each said object, data in which information indicating an object and a control constant that said refrigerating driving control section adopts for that object are associated together.

28. The refrigerating apparatus control method according to claim 21, further comprising a step of:
(e) performed prior to said steps (a) to (d), storing in said control constant storage section, and for each said object, data in which information indicating an object and a control constant that
said refrigerating driving control section adopts for that object are associated together.
